(19) United States
(12) Patent Application Publication
(10) Pub. No.: US 2021/0170706 A1
(43) Pub. Date: Jun. 10, 2021

(54) MANUFACTURING METHOD OF INJECTION MOLDED COMPOSITE SHOE SOLE AND SOLE THEREOF

(71) Applicants: DEAN SHOES COMPANY LTD, Taichung City (TW); SHUN CHAN INDUSTRY CO.,LTD, Taichung City (TW)

(72) Inventors: CHEN-YUAN HUANG, Taichung City (TW); CHIEN-CHIH LU, Taichung City (TW)

(21) Appl. No.: 17/181,630

(22) Filed: Feb. 22, 2021

Related U.S. Application Data
(62) Division of application No. 16/190,970, filed on Nov. 14, 2018.

(51) Int. Cl. B29D 35/14; B29C 45/14; B32B 7/12; B32B 25/08; A43B 13/02; A43B 13/04; A43C 15/02; A43C 15/16; A43B 13/12; B29D 35/00

(52) U.S. Cl. CPC B29D 35/142; B29C 45/14065; B29C 45/14311; B32B 7/12; B32B 25/08; A43B 13/026; B29K 2075/00; A43C 15/02; A43C 15/16; A43B 13/12; B29D 35/0018; B32B 2437/02; A43B 13/04

(57) ABSTRACT

A manufacturing method of an injection molded composite shoe sole and the sole thereof are provided. The method includes facial modifying, cleaning a combination face of an additional component formed of a material different from the sole material, and coating a facial process layer on the combination face, and drying to modify the combination face; gumming, placing a gum layer on the facial process layer on the modified combination face; in-mold positioning, placing additional component into a mold; and injection molding, injecting the sole material into the mold, thereby gumming the sole material and the gum layer of the combination face to form a composite shoe sole. Therefore, the manufacturing method effectively reduces the sole manufacturing time.

### CROSS REFERENCE TO RELATED APPLICATIONS

This application is a Divisional of co-pending application Ser. No. 16/190,970, filed on Nov. 14, 2018, for which priority is claimed under 35 U.S.C. § 120; the entire contents of all of which are hereby incorporated by reference.

### BACKGROUND OF THE INVENTION

### 1. Field of the Invention

The present invention relates to composite shoe soles, and more particularly, to a manufacturing method of injection molded composite shoe sole and sole thereof, wherein the injection molding material is combined with different material during the injection process.

### 2. Description of the Related Art

In a conventional shoe manufacturing field, shoes are often provided with accessories or cleats made of different material from the shoe sole. However, different materials are difficult to be combined, causing a less optimal product quality. Therefore, the industry has developed relative improvements. Referring to TW patent 1601491, a manufacturing method of shoe having cleat made of different material is disclosed, comprising steps of: preforming shoe cleats, in-mold positioning, facial processing, in-mold gluing, mold combining, sole material injecting, hot-melting combining, and mold separating. In the facial processing step above, a preformed shoe cleat is placed in the mold, and the shoe cleat undergoes the facial process and is coated with glue. Then, melted sole material is injected into the mold, such that the sole material is cooled down to be solidified into the shoe sole.

However, during the facial processing operation upon the shoe cleat, the treating agent and glue easily foul the internal structure of the mold. As a result, the overall manufacturing time is prolonged, and even the yield rate is affected. Further, based on the fact that the mold is usually under a high temperature environment, the danger during the facial processing of the shoe cleat is increased.

### SUMMARY OF THE INVENTION

For improving the issues above, a manufacturing method of injection molded composite shoe sole is disclosed, which is able to increase the shoe manufacturing efficiency and also resolve the possible pollution during the combination of shoe cleats and the shoe sole, so as to improve the combination quality thereof.

For achieving the aforementioned objectives, a manufacturing method of injection molded composite shoe sole is provided, comprising following steps:

(a) facial modifying, cleaning a combination face of an additional component formed of a material different from the sole material, and coating a facial process layer on the combination face, and drying to modify the combination face;

(b) gumming, placing a gum layer on the facial process layer on the modified combination face;

(c) in-mold positioning, placing the additional component into a mold; and

(d) injection molding, injecting the sole material into the mold, thereby gumming the sole material and the gum layer of the combination face to form a composite shoe sole, wherein the components are combined to the bottom or peripheral portions of the composite shoe sole.

A composite shoe sole in accordance with an embodiment of the present invention is also provided, comprising a sole body and an additional component. The sole body has a sole face. The additional component is formed of a material different from the material of the sole body. The additional component has a combination face, which is combined with the sole face of the sole body, with a facial process layer and a gum layer disposed between the sole face and the combination face. The facial process layer is pre-formed on the combination face, and the gum layer is disposed between the facial process layer and the sole face.

With such configuration, the composite shoe sole is formed by the additional component and the sole material that are made of different materials. Regarding the overall shoe manufacturing process, the additional component undergoes the facial processing operation in advance, and is subsequently placed into the mold, so as to reduce the possible pollution caused upon the mold and increase the yield rate of the composite shoe sole thereby manufactured. Also, the facial processing outside of the mold further reduces the overall manufacturing time and helps improving the safety during the manufacturing process.

### BRIEF DESCRIPTION OF THE DRAWINGS

FIG. 1 is a flow chart of the manufacturing method of the composite shoe sole in accordance with an embodiment of the present invention.

FIG. 2 is a flow chart of the facial modifying process of the present invention.

FIG. 3 is a flow chart of the gumming process of the present invention.

FIG. 4 is a schematic view illustrating operation status of the injection molding process of the present invention.

FIG. 5 is a perspective view of the composite shoe sole in accordance with an embodiment of the present invention.

FIG. 6 is a partially sectional view of the composite shoe sole in accordance with an embodiment of the present invention.

FIG. 7 is a perspective view of the composite shoe sole in accordance with another embodiment of the present invention.

### DETAILED DESCRIPTION OF THE INVENTION

The aforementioned and further advantages and features of the present invention will be understood by reference to the description of the preferred embodiment in conjunction with the accompanying drawings.

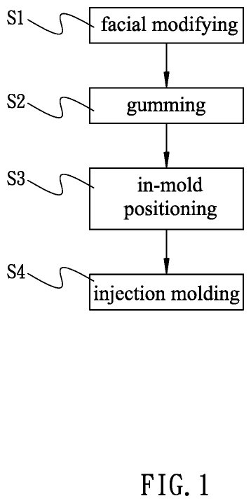

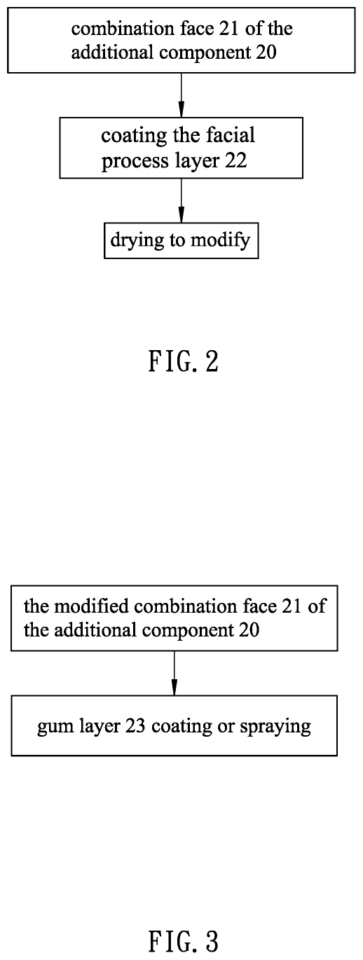

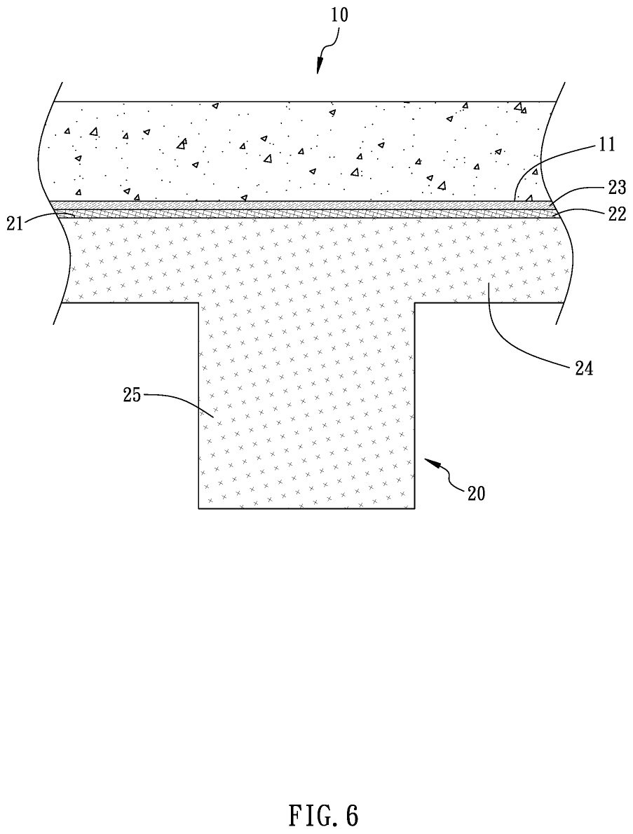

Referring to FIG. 1 to FIG. 7, a manufacturing method of injection molded composite shoe sole 100 and the composite shoe sole 100 thereof are provided. The composite shoe sole 100 comprises a sole body 10 and an additional component 20 formed of a material different from the material of the sole body 10. The sole body 10 is formed of a sole material selected from TPU (thermoplastic polyurethanes), PA (Nylon), or TPE (thermoplastic elastomer) through a cooling process, with a sole face 11 on the bottom or peripheral portions thereof. The additional component 20 has a combination face 21, which is combined with the sole face 11 of the sole body 10. The manufacturing method of the injection molded composite shoe sole 100 comprises following steps: facial modifying S1; gumming S2; in-mold positioning S3; and injection molding S4.

In the facial modifying S1, the combination face 21 of the additional component 20 is cleansed by use of water or detergent, such that the impurity on the combination face 21 is removed. In an embodiment of the present invention, the additional component 20 refers to protrusion, shoe cleats, or sole pat formed of rubber material or other material different from the material of the shoe sole. Next, a facial process layer 22 selected from, for example but not limited to, an environmental friendly oil-based benzene free treating agent is coated on the combination face 21 of the additional component 20. Besides, a water-based treating agent is also allowed to be applied according to different combination between the material of the additional component 20 and the sole material. After the coating of the facial process layer 22 upon the combination face 21, the combination face 21 of the additional component 20 undergoes a drying process to be modified. In an embodiment of the present invention, the facial process layer 22 is dried in a temperature between 50 to 80 Celsius degrees for 3 to 5 minutes for completing the facial modification of the combination face 21.

In the gumming step S2, a gum layer 23 is disposed on the combination face 21 which is provided with the facial process layer 22. In an embodiment of the present invention, the gum layer 23 is formed of material selected from polyurethane, polymethylmethacrylate, or epoxy glue, which is coated or sprayed upon one face of the facial process layer 22. In an embodiment of the present invention, the gum layer 23 is dried in a temperature between 50 to 80 Celsius degrees for 3 to 5 minutes for completing the gum coating process.

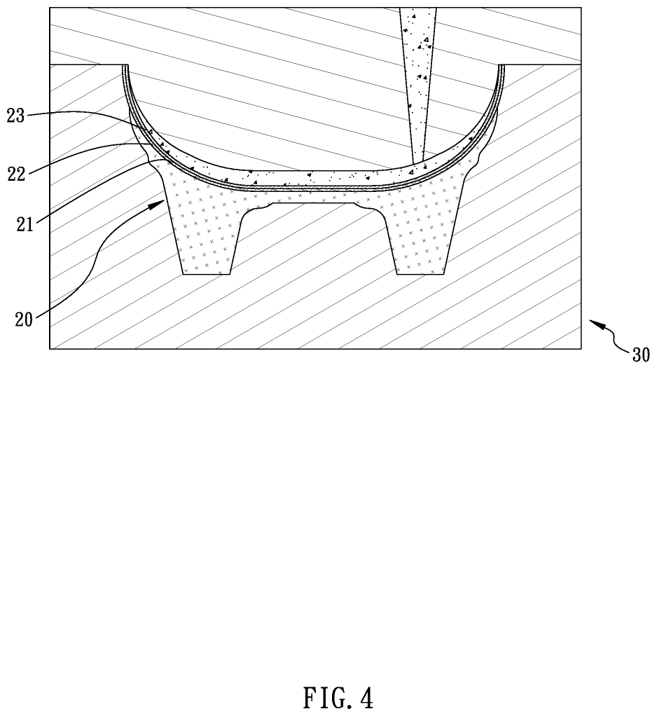

In the in-mold positioning step S3, as shown by FIG. 4, after the gumming process, the facial processed additional component 20 is placed in a mold 30 to be positioned therein, while the combination face 21 is prevented from contacting the inner wall of the mold 30 as much as possible. Therefore, the facial process layer 22 and the gum layer 23 of the additional component 20 do not internally pollute the mold 30.

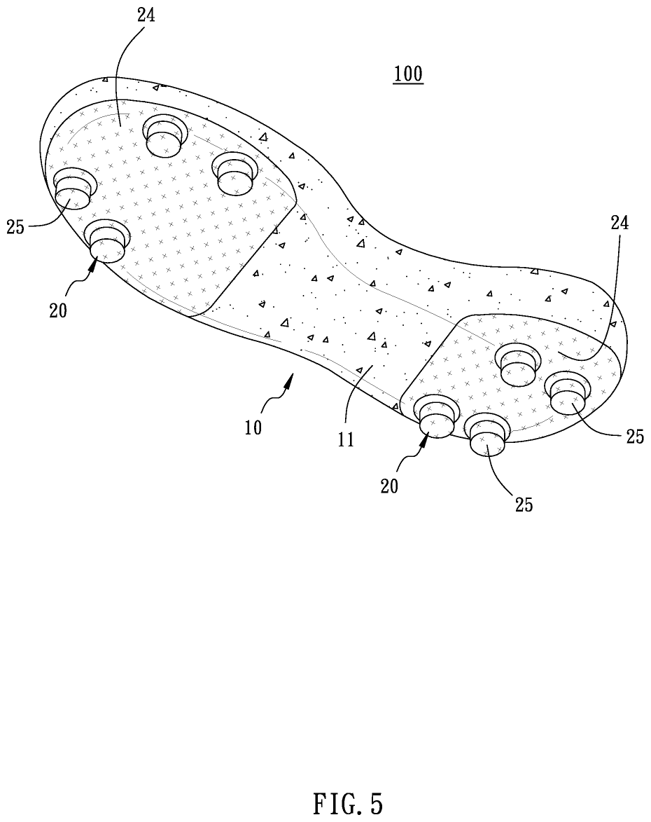

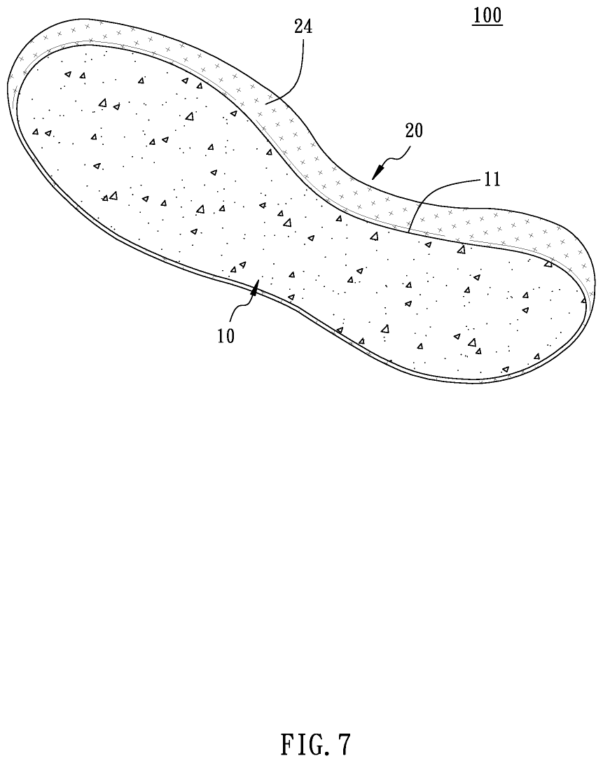

In the injection molding step S4, the sole material of the sole body 10 is injected in the mold 30. The hot-melted sole material flows along the structural shape of the mold 30, such that the sole material is combined with the gum layer 23 on the combination face 21 of the additional component 20. After a vulcanization and cooling process, the sole material is solidified into the sole body 10. At the meantime, the facial process layer 22 and the gum layer 23 are disposed between the combination face 21 of the additional component 20 and the sole face 11 of the sole body 10, and the gum layer 23 is combed between the facial process layer 22 and the sole face 11 of the sole body 10, such that the additional component 20 is gummed on the bottom or the peripheral portion of the sole body 10, forming the composite shoe sole 100. For example, as shown by FIG. 5, the sole face 11 is positioned on the bottom portion of the sole body 10. When the additional component 20 is disposed on the sole face 11, the additional component 20 has a base portion 24 and a plurality of convex portions 25 disposed on the base portion 24. The combination face 21 is disposed on the inner lateral side of the base portion 24, and the convex portions 25 are disposed on the outer lateral side of the base portion 24. In an embodiment of the present invention, the convex portions 25 are provided in an amount of four, and are averagely distributed on the outer lateral side of the base portion, such that the additional component 20 forms a shoe cleat structure. As shown by FIG. 7, the sole face 11 is positioned around the sole body 10, and the additional component 20 has a base portion 24 mounted around the sole face 11 of the sole body 10 to form a protection pad structure thereon.

Notably, when the additional component 20 is formed of a material identical to the sole material, based on the fact that the same material have identical properties, the facial modifying process S1 in the manufacturing method is allowed to be skipped, such that the manufacturing method accordingly begins from the gumming step S2 to the injection molding step S4, thus shortening the overall time cost and improving the manufacturing efficiency.

With such configuration, the additional component 20 and the sole material are combined to form the composite shoe sole 100. During the manufacturing process, the additional component 20 undergoes the facial processing in advance and is placed into the mold 30 afterward, reducing the possible pollution of the treating agent upon the mold 30 and increasing the yield rate of the composite shoe sole 100. Also, such facial processing of the additional component 20 outside the mold 30 not only reduces the time cost of the manufacturing process, but also improves the safety during the manufacturing process.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A manufacturing method of injection molded composite shoe sole, comprising following steps:
(a) facial modifying, cleaning a combination face of an additional component formed of a material different from a sole material, and coating a facial process layer on the combination face, and drying to modify the combination face;
(b) gumming, placing a gum layer on the facial process layer on the modified combination face of the additional component;
(c) in-mold positioning, placing the additional component into a mold to be positioned therein; and
(d) injection molding, injecting the sole material into the mold, thereby gumming the sole material and the gum layer of the combination face to form a composite shoe sole, wherein the additional component is combined to a bottom or peripheral portion of the composite shoe sole.

2. The manufacturing method of claim 1, wherein in the gumming step, the gum layer is coated or sprayed on one face of the facial process layer.

3. The manufacturing method of claim 2, wherein in the gumming step, the gum layer is formed of a material selected from a group consisting of polyurethane, polymethylmethacrylate, and epoxy glue; the gum layer and the facial process layer are dried in a temperature ranging from 50 Celsius degrees to 80 Celsius degrees for a time ranging from 3 minutes to 5 minutes, so as to be combined together.

4. The manufacturing method of claim 1, wherein in the facial modifying step, the facial process layer is a benzene free treating agent, and the facial process layer is dried in a temperature ranging from 50 Celsius degrees to 80 Celsius degrees for a time ranging from 3 minutes to 5 minutes, so as to modify the combination face.

5. The manufacturing method of claim 1, wherein the additional component is selected from a group consisting of protrusion, shoe cleat, and sole pat that are formed of rubber material, and the sole material is selected from a group consisting of TPU (thermoplastic polyurethanes), PA (Polyamide), and TPE (thermoplastic elastomer).
